(19) United States
(12) Patent Application Publication
(10) Pub. No.: US 2021/0357854 A1
(43) Pub. Date: Nov. 18, 2021

(54) LOGISTIC PROCEDURE FOR GOODS TO BE SOLD AND PACKAGES TO BE SHIPPED, PACKAGE RECEIVING STATION AS WELL AS STORE FOR THE IMPLEMENTATION OF THIS PROCEDURE

(71) Applicant: Lidl Dienstleistung GmbH & Co. KG, Bad Wimpfen (DE)

(72) Inventors: Matthias Oppitz, Bad Wimpfen (DE); Rene Engel, Bad Wimpfen (DE); Dominik Eberhard, Bad Wimpfen (DE)

(73) Assignee: Lidl Dienstleistung GmbH & Co. KG, Bad Wimpfen (DE)

(21) Appl. No.: 17/241,309

(22) Filed: Apr. 27, 2021

(30) Foreign Application Priority Data
Apr. 27, 2020 (DE) 102020111395.1

(51) Int. Cl. G06Q 10/08; G06Q 10/06; G07B 17/00; G06Q 20/18; G06K 7/14; G06Q 20/20; B65G 47/04

(52) U.S. Cl. CPC G06Q 10/0837; G06K 2007/10504; G06Q 10/087; G06Q 10/0833; G07B 17/00661; G06Q 10/08345; G06Q 20/18; G07B 17/0008; G06K 7/1413; G06K 7/1417; G06Q 20/208; G06Q 20/202; B65G 47/04; G07B 2017/00685; G07B 2017/00701; G06Q 2250/50; G07B 2017/00717; G06Q 10/06315

(57) ABSTRACT

The invention relates to the logistical linking of package flows with goods flows by positioning common package acceptance stations (gPAS) at or in goods-sales-branches (WVF) where the goods (W) aresold.

### I. APPLICATION AREA

The invention relates, on the one hand, to the logistical handling of goods that must be delivered to goods-sales-branches and sold there to customers and, on the other hand, to the logistical handling of packages, in particular returned packages, that are sent to recipients by the same customers.

### II. TECHNICAL BACKGROUND

Today, these two product streams are largely separated:

Goods-sales-branches such as supermarkets or discount stores, in which goods are sold to end consumers, are generally supplied with goods from area-specific central warehouses by means of transport vehicles, usually trucks—which is why the delivery vehicles are referred to only by the abbreviated form truck in the context of this application—which, however, generally do not drive back completely empty on their return trip to the central warehouse, but can bring back to the central warehouse transported goods, such as
packages returned to the goods sales branch, especially empty refunded cans and bottles,
outer packaging collected in the goods sales branch and in particular compressed into bales,
Goods returns, in particular in the form of given back goods, remaining stock of goods or stock of goods to be transferred to other goods sales branches.

Packages, which have to be transported in particular due to online trade, are brought by different package logistic companies via their area-specific central package warehouses by means of delivery vehicles to the customers, usually end consumers. Return packages—for some groups of goods the share is known to be 50% and more—are taken by the recipient of the package=sender of the returned package to a package acceptance station—usually of the same package logistic company who delivered the package to him—and from there it is taken to the central package warehouse by means of one of the delivery vehicles of the package logistic company and from there it goes to the recipient, usually the original sender of the package.

Most of the original senders offer the return transport of the package free of charge. Nevertheless, to deposit the return package, the customer must go to the logistic company specific package acceptance station of this package logistic company to deposit the package there, because the package logistic companiesdo not yet operate any common package acceptance stations.

On the one hand, these logistic company specific package acceptance stations are sometimes relatively far away from the customer, and on the other hand, they often have very specific opening hours and, depending on the package acceptance station, there may be long waiting times for the depositing customer.

Furthermore, the acceptance capacity and/or storage capacity for packages dropped off there is usually very limited and often spent.

The same applies to the customer if he does not want to deposit a return package, but wants to send a self-created package, a so-called primary package, as he then also has to pay for the delivery, either at the logistic company specific package acceptance station or, preferably beforehand, online.

To solve the problem of customers not being present at home when packages are delivered, there are package delivery stations in form of lockbox systems where the package is deposited for the customer, who can pick it up from there. These package delivery stations are located in buildings or outdoors, whereby good accessibility for the customer is important, especially still also by car.

Some of these package delivery stations are also equipped to accept packages, especially return packages, but rarely if ever accept primary packages.

The connection between these logistic streams that has been practiced up to now is merely that such unmanned package delivery stations are located in the parking lots of goods sales branches such as supermarkets or discounters, but usually relatively far away from the sales building, since for the goods sales branches the areas of its parking lot close to the building are important as parking spaces for its customer loyalty.

Especially in the dark, it is not pleasant for the package customer to drive to the package station, which is sometimes difficult to see, in a remote part of the area to hand out or accept his package, and in addition he can often only do this during the opening hours of the goods sales branch, as the parking area of the goods sales branch is only open at these times.

Furthermore, due to the outdoor location, such a package station is only suitable to a limited extent for temperature-sensitive goods, despite thermal insulation.

The package customer must therefore know,
at which goods sales branch a package delivery station is located,
whether it is embodied as a package acceptance station,
whether the package acceptance station currently still has acceptance capacity,
by which logistic company this package station is operated,
where on the parking area the package station is located and
at what times the package station is accessible.

These logistic company specific package stations are filled and emptied directly by the logistic company, i.e. its delivery vehicles.

### III. PRESENTATION OF THE INVENTION

### a) Technical Object

It is therefore the object according to the invention to couple the logistics streams of goods and packages in order to offer the customer a handling advantage on the one hand and to reduce the logistical effort in the form of vehicle movements and provision of package stations, especially package acceptance stations, on the other hand.

### b) Solution of the Object

This task is solved by the features of claims 1, 14 and 19. Advantageous embodiments result from the subclaims.

With regard to the method, the logistic streams of goods to be sold on the one hand and packages to be sent on the other hand are coupled according to the invention:

Goods that are to be sold to customers in goods sales branches are distributed via central warehouses to the goods sales branches located in their distribution area, i.e. they are transported from the central warehouse to the individual goods sales branches by means of goods trucks.

These goods trucks carry far less material on the return trip, including empty packaging.

On the other hand, packages are deposited by customers for dispatch at package acceptance stations and transported from there to a package logistic company's central warehouse. A relatively high percentage of these are returned packages, in which goods received by package, usually purchased online, are returned to the sender.

According to the invention, these logistic streams are coupled by the fact that these packages are not deposited by the customer at a logistic company specific package acceptance station, but at a so-called “common package acceptance station”, at which different packages can be deposited, each of which is to be transported by a specific one of several different logistic companies available for selection, and for which these common package acceptance stations are positioned in or close to a goods sales branch, i.e. at least on its area with the customer parking spaces.

The customer can therefore drop off most or all of his packages—in the case of returned packages, it is usually specified via which logistic company they have to be returned—at this common package acceptance station, which has a number of advantages for him:
The customer saves additional travel and time for dropping off packages, especially his return packages, to a separate logistic company specific package acceptance station specified for him in each case, and he can carry out his goods purchases at the same place, i.e. on the same area, in the goods sales branch,
this commonpackage acceptance stationis are easy for him to drive to, as there is usually a sufficient number of parking spaces available on the area of the goods sales branch,
he avoids the long waiting times that are common at logistic company specific acceptance stations and the risk that his package will not be accepted there in the end because the receiving capacity of this logistic company specific acceptance station is currently spend,
he is much more flexible in his daily planning, since for the return of the package or depositing of a primary package at the common package acceptance station, he has the familiar and long, customer-friendly opening hours of the goods sales branch at his disposal, while the package acceptance stations for each station are only available to him at very specific opening hours, which are also much shorter.

The packages deposited at the common package acceptance station are sorted according to the various package logistic companies and handed over to them. The packages are transported to the package central warehouses of the individual package logistic company.

This can be done in a variety of ways:

Preferably, the packages are first transported from the goods-sales-branch where the common package acceptance station was located to a central goods warehouse by means of a goods truck, which in any case drives to the goods-sales-branch for the delivery of goods and can pick up the packages on its return trip to the central goods warehouse.

The sorting of the packages can take place at different points in time during this process, but at the latest in the goods central warehouse, possibly earlier, possibly already at the common package acceptance station, or at a point in time in between.

From the goods central warehouses, the packages are sorted according to the individual logistic companies and transported to the central package warehouses of the individual logistic company, which is then preferably done by the logistics company, i.e. using its goods trucks.

If the packages are already sorted by package logistic company in the goods sales branchs, i.e. at the respective common package acceptance stations there, they could also be transported from there directly to the package logistic company package central warehouses, but then preferably by means of the package delivery trucks or goods trucks of the package logistics company.

This would avoid the detour via the goods central warehouses and the resulting loss of time, but the collection effort for the package logistic company would be higher, as he would have to drive to a significantly higher number of goods sales branchs compared to the much smaller number of goods central warehouses. In addition, the capacity of the goods trucks on their return trip could not be fully utilized.

In both cases, however, the advantages for the package logistic company are that his effort to collect the deposited packages is reduced and he may even get by with a smaller number of logistic company specific package acceptance stations that he operates himself, which drastically reduces his operating costs.

For the operator of the goods-sale branches, this approach offers the advantage of increasing loyalty to its customers, who want to take advantage of the benefits of common package acceptance stations at its goods sales branches because of their advantages.

The benefits for these three players can be further enhanced by additional measures in the method:

Since the common package acceptance stations are partially or, in particular, completely automated and can be operated unmanned, the operator, who is generally also the operator of the goods sales branch there, requires no or hardly any additional personnel.

Above all, however, the number of acceptance terminals in such a common-package acceptance station can then be very easily adapted to demand, so that the customer has the advantage that he has little or no waiting time to worry about when depositing his package there.

If, after the package has been handed over there, the customer receives a handover receipt in paper form, or receives it on his smartphone or by e-mail, on which the time of handover and/or the package logistic company indicated on the package, who will carry out the further delivery process of the package, is indicated and/or a corresponding transport ID, with the help of which the online tracking of the package on its way by the customer is possible, the customer can also track the route of his package and its delivery to the recipient, as in the case of handover at a logistic company specific acceptance station.

Since some of the packages, in particular so-called primary packages, which the customer has created himself and which are not return packages, have to be franked before they are transported, it is advantageous for the customer if this franking can also be carried out, preferably automatically, at the common-package acceptance station, in particular if it can be paid cashlessly, or if the customer can pay the fee for package transport online beforehand.

The customer then does not even have to visit a staffed, logistic company specific receiving station for such primary packages, which usually involves waiting time and travel.

Since the package logistic company is not specified for primary packages in particular, the customer can select a particular package logistic company at his own discretion—at the latest at the common package acceptance station—either depending on the transport fee, which usually differs for the individual package logistic company, or according to other criteria, such as the quality or speed of transport and delivery.

Preferably, however, at least the transport fee charged by the individual package logistic companies is communicated to the customer in advance when the package is handed over at the common package acceptance station, and the customer can then select the package logistic company.

This is an advantage that is no longer offered to the customer when he previously decides on a specific package logistic company by visiting a certain logistic company specific acceptance station. In this case, they would have to find out in advance online about the various transport fees for their specific package—which may depend on different parameters for the individual logistic companies—and then make this decision.

Since there is either an identifier on the package that is checked in that reflects the package logistic company that is to transport the package, or such a package logistic company is entered by the customer when the package is checked in at the control unit, there is on the one hand the possibility of automatically feeding this package, while it is still at the common package acceptance station, to a collector container that is specific to this package logistic company.

This saves the later sorting of the packages according to the individual package logistic company, for example in the goods central warehouse, and even enables the collection of the collector containers by the individual package logistic companies in the individual goods sales branch.

It is also possible to inform the package logistic company in real time, for example every day or several times a day or even just-in-time, about the number of packages delivered to the individual goods sales branches or to the distribution area of a goods central warehouse, so that he can adjust his logistics planning accordingly.

If the recipient is also identified, in particular scanned, on the packages during depositing, the individual recipients can also be communicated to the package logistics company, so that the package logistics company can, for example, immediately recognize a conspicuous accumulation of recipients, which he can also take into account in the planning of his future logistics, or which can, for example, indicate to him at a very early stage an accumulated return to a particular recipient and thus presumably of a particular product.

If the packages accepted also include return packages from the online store operated by the operator of the goods sales branches, the latter is informed about these return packages at a very early stage and can react to increased numbers, for example, by initiating quality checks and/or carry out product recalls.

If the physical data of the package is also determined when the packages are accepted, such as the weight and/or dimensions, in particular also the shape, of the package, and this is additionally communicated to the package logistic company—or in the latter case to the operator of the goods sales branches and the affiliated online store—the latter can in many cases deduce from this which return product is involved in the respective packages and determine an increased return of a particular product very early on and react to this.

Knowledge of the weight and/or dimensions, especially even the shape, of the packages is also advantageous for planning transport capacities.

In order to be able to verify evaluation results from the above findings, additional plausibility checks can be carried out, especially at the common package acceptance station:

For example, when a filled collector container is removed from the package acceptance station, its weight can be determined, for example by placing the collector container that is currently in use, i.e. into which the fed packages fall after passing through the input channel, on a scale and weighing it continuously, or by weighing the individual packages beforehand as they pass through.

The weight of the removed, filled collector container can then be compared with the sum of the weights of the checked-in packages since this collector container was placed in the package acceptance station, and if there is a relevant difference here, this suggests a functional fault in the receiving station or a theft, for example to the effect that a checked-in package did not reach the collector container.

The same can be done when checking the filling volume of the collector container and determining the volume of the loaded packages in terms of volumes, but it is more error-prone when the packages fall freely into the collector container and thus form a loose bulk with more or less large gaps.

In the case of returned packages, customers often face the problem that they do not have the appropriate packaging materials at home to properly package such a package for return delivery.

For this case, it is convenient for the customer if the appropriate packaging material is made available to him at the place of the common package acceptance station, for example adhesive tape and/or wrapping paper and/or folding cartons in various sizes, regardless of whether this is made available to him free of charge or, especially in the case of whole folding cartons, against payment.

The package acceptance station can also be used for customers to donate to local food banks that give out food or meals to those in need for free:

Either in the form of goods in kind, in that the customer—preferably previously purchased in the goods sales branch—places foodstuffs, preferably previously packaged as a package, in the input opening of the common package acceptance station and selects as recipient on the operating unit one of the local food banks available there, whereupon the deposited goods are automatically deposited in a donation container.

Alternatively, these goods do not necessarily have to be physically placed in the input opening, but the customer can simply declare certain goods offered in the neighboring goods sales branch as a donation to the food bank at the operating unit and pay for them at the operating unit.

A donation in this form can then be placed in the donation container for the food bank in the refund room or logistics room—usually manually by the staff of the goods sales branch—or a shopping voucher for the goods sales branch is sent to the food bank for this amount.

Since the common package acceptance station preferably operates fully automatically and thus unmanned, and is thus not subject to constant personal monitoring by the staff of the goods sales branch, automatic monitoring of the package acceptance stations hould be provided, especially if it is located in an outer wall of the building, and thus can be visited by unauthorized persons outside opening hours even when the barrier at the entrance to the area is closed.

The package acceptance station could be equipped with motion detectors and/or acceleration sensors that detect and automatically report an unauthorized, strong impact on the acceptance station, such as an attempt to break it open.

Preferably, there is then a signal connection with the nearest police station, which in this case can drive to and control the common package acceptance station, i.e. the corresponding goods sales branch.

Consideration should also be given to monitoring the area at and immediately in front of the acceptance station by having their fotos or videos constantly monitored by personnel such as of a security company.

The next stage of expansion of the common package acceptance station is that it can additionally perform the delivery of packages received from package logistic companies to the customer, as at package delivery stations already known today in the form of controlled lockbox systems.

At such a common package acceptance station, appropriately controlled lockbox can also be provided for this purpose, each of which contains a package for the customer, so that the corresponding lockbox is automatically opened for the customer as soon as he has proven his authorization to receive the package contained therein at the operating unit, for example by reading in a confirmation of receipt which the customer has received by mail and can have printed out or scanned from his smartphone by the scanner of the operating unit, including markings arranged thereon such as a QR code.

Instead of the known controlled lockboxes, the corresponding package can also be handed out to the customer via the input channel upon proof of his authorization by operating the conveyor there in the reverse direction and handing out a package placed inside the common package acceptance station to the input opening.

With regard to an automatic package acceptance system with at least one common package acceptance station, this comprises an input opening, which is preferably adjoined by an input channel, as well as inside the station, i.e. no longer accessible to the customer—in that a reach-through prevention device, i.e. a reach-through protection device, is located behind the input opening—a collector container, into which the accepted packages that have passed through the input channel are automatically deposited, in particular simply fall in.

For this purpose, a transport device is provided to move the package along the input channel, in the simplest case a chute, but preferably a controlled transport device such as a conveyor belt, which can be moved in a controlled manner by an electric or electronic control of the acceptance station.

Such a package acceptance system, in particular each individual package acceptance station, further comprises a scanner for reading the package information indicated on the package, in particular on its label, namely at least the logistician identifier present on the package, which indicates the logistic company who has to transport this package, and which is applied there preferably in the form of a QR code or a barcode or another optically detectable marking, preferably in such a way or so often that the logistician identifier is recognizable from all sides of the package, e.g. in the form of a transparent, in particular circulating band for recognizability over 360° of the circumference of the package, e.g. in the form of a transparent, in particular circumferential band for recognizability over 360° of the circumference of the package, in that the band is printed in particular continuously with the logistician identification.

This saves the customer from having to enter the corresponding package logistic copany manually, for example via the keyboard of an operating unit, which is also always prone to errors.

The scanner is preferably arranged in the course of the input channel, i.e. in any case at or behind the input opening, preferably at several points of the circumference of the input opening or the input channel, so that such a marking can be read regardless of which visible side of the package it is located, apart from the bottom side.

Such a scanner can instead and/or additionally also be part of an operating unit, which however requires that the customer manually holds the package with this marking to the scanner.

Such an operating unit can furthermore have a screen, in particular in the form of a touch-sensitive screen, i.e. a touch display, and/or a keyboard or other input means for information to the control system of the receiving station.

Furthermore, such a control unit should include a payment unit for, in particular, cashless payment, for example, an EC terminal or a credit card terminal, as well as an issuing device with which an acceptance receipt generated by the acceptance station regarding the acceptance of the package is issued to the customer after the package is irrevocably located in the package acceptance station and can no longer be retained or withdrawn by the customer.

For the reasons explained above, the common package acceptance station should have a weighing scale for weighing the deposited package, especially under the transport device in the input channel, which should of course be signal-connected to the acceptance station control system.

Furthermore, additional measuring devices can be present on or in the input channel for determining the dimensions, in particular the largest dimension, and thus the volume or even the shape of the package. Especially when this measuring device is coupled with the targeted control of the movement of the transport device, the complete dimensions of the package can be determined by means of simple distance sensors. For example, by means of a distance sensor above the transport device, not only the height of the package can be determined, but also the beginning and end of the package passing through can be determined by the distance sensor, and the length of the package in the direction of passage can be determined by the transport distance covered by the transport device between these points.

Furthermore, a position sensor and/or a movement sensor can be present, preferably in the course of the input channel. By means of the position sensor, it can be determined whether the package is already behind the pass-through protection and thus irrevocably in the acceptance station, whereupon the delivery receipt can be issued to the customer.

By means of a motion sensor, it can be checked whether the package is moving in a direction and at a speed that does not correspond to the direction or speed of the transport device on which it is located, for example because the customer moves the package, for example tries to pull it back, e.g. by means of a cord attached to it. Especially in the case of high-priced contents, there could be an incentive for the customer to obtain a delivery receipt for the package without allowing the package to enter the package acceptance station.

Furthermore, a filling level sensor for the at least one collector container in use may be provided, for example at the rear of the acceptance station, such as at or below the rear end of the input channel, so that it can be replaced with an empty one by the personnel of the goods sales station when it is completely full.

If the packages are to be sorted according to logistic companies at the individual common package acceptance stations, there should be various collector containers assigned to the individual package logistic companies, and the receiving station should include an automatic switch for feeding a package to the correct collector container depending on the recognized logistician ID present on the package.

For the reasons given above, the receiving station may also include automatic outputs for packing material, in particular wrapping paper and/or tape, and preferably also a work table on which the customer can finish packing of his brought, not yet finished, package.

The security monitoring of the package acceptance station can include at least one camera filming the front and/or back of the package acceptance station as well as the area in front of the station and/or motion detectors or acceleration sensors, which is data-connected either to a security company or directly to the nearest police station.

For the customer, there should be an emergency button as a safety feature, preferably so close to the input opening that he can still press it while holding the package in the input opening with one hand, so that he can still press the emergency button with the other hand at the same time, for example in case he gets caught in the transport device or the reach-through protection.

The emergency button is preferably signal-connected to the staff of the goods-sales branch and, outside its opening hours, to a security service.

With regard to the goods sales branch, this object is solved by the fact that it includes a common package acceptance station as described above.

The receiving station can be located inside the building of the goods sales branch, and if there is a return room separate from the goods sales room, for example for the return of refunded containers, preferably in this return room.

However, the common package acceptance station can also be located in an external wall of the building, so that the customer does not have to enter the building to use it.

The common package acceptance station can also be located as a separate building on the area of the goods sales branch away from the building of the goods sales branch, but preferably as close to it as possible, since the area are, after all, generally much larger than the building of the store itself, since they have, in particular, a larger number of parking spaces.

In particular, the common package acceptance station can also be designed as a drive-in station on the area of the goods sales branch, so that one can drive with the car so close to the input opening and the correspondingly arranged operating unit that one can place the package in the input opening through the open window of the driver's seat while sitting in the car and operate the operating unit.

This allows the customer to avoid leaving their vehicle, which they will find to be a safety benefit, especially in the dark.

The security equipment of the common package acceptance station is preferably part of the security equipment of the goods sales branch, so that the connection with a security company and/or a police station is needed only once.

### C) EXAMPLES OF EMBODIMENTS

Embodiments according to the invention are described in more detail below by way of example. It shows:

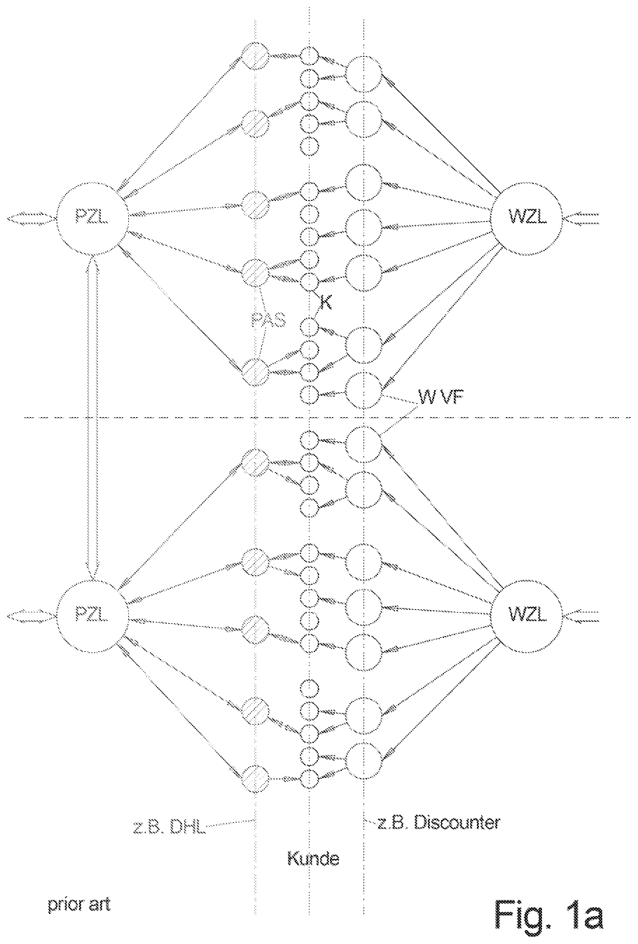

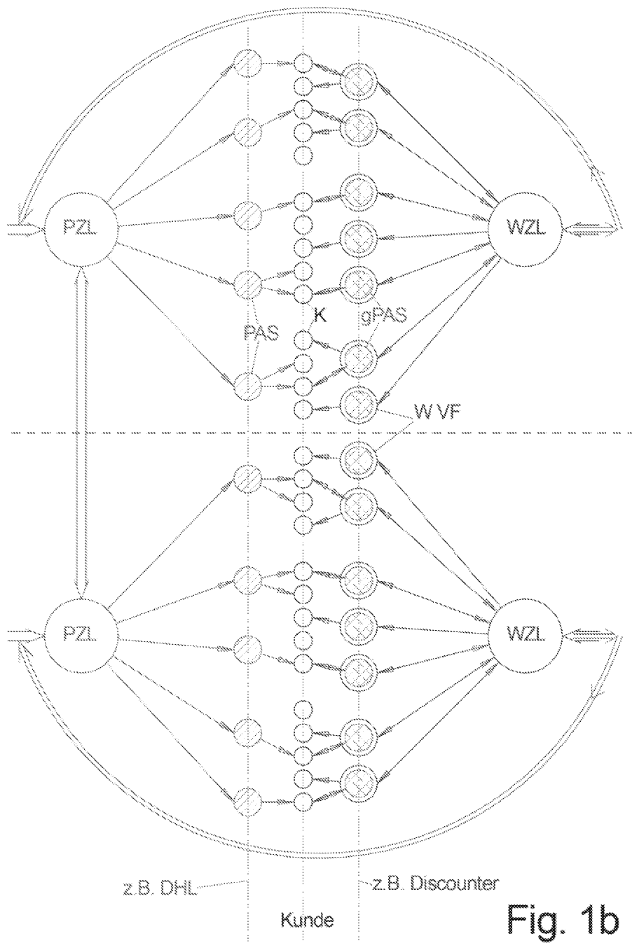

FIG. 1a: a prior art logistic scheme,

FIG. 1b: the logistic scheme according to the invention,

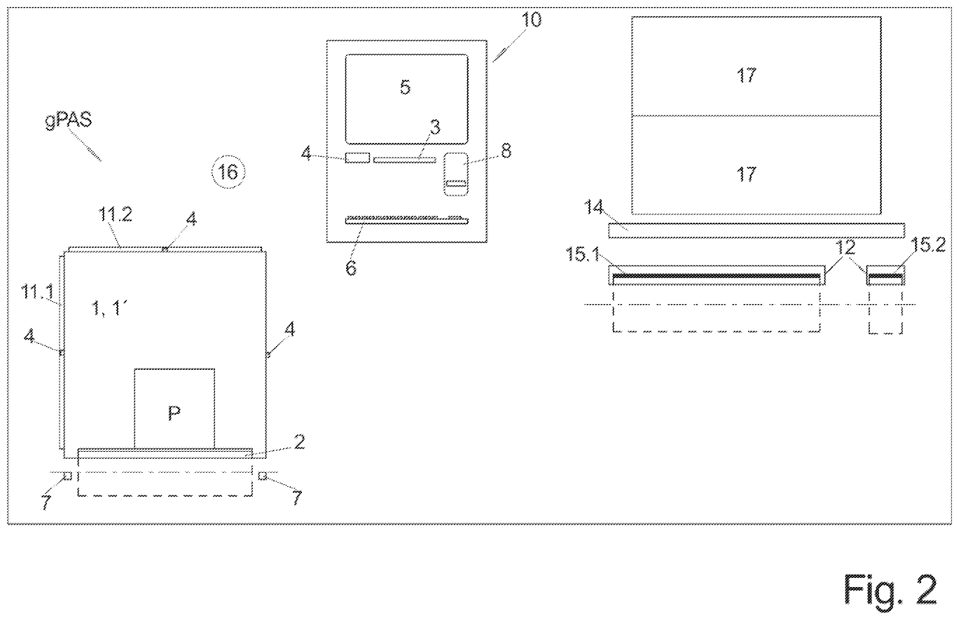

FIG. 2: a common package acceptance station in front view,

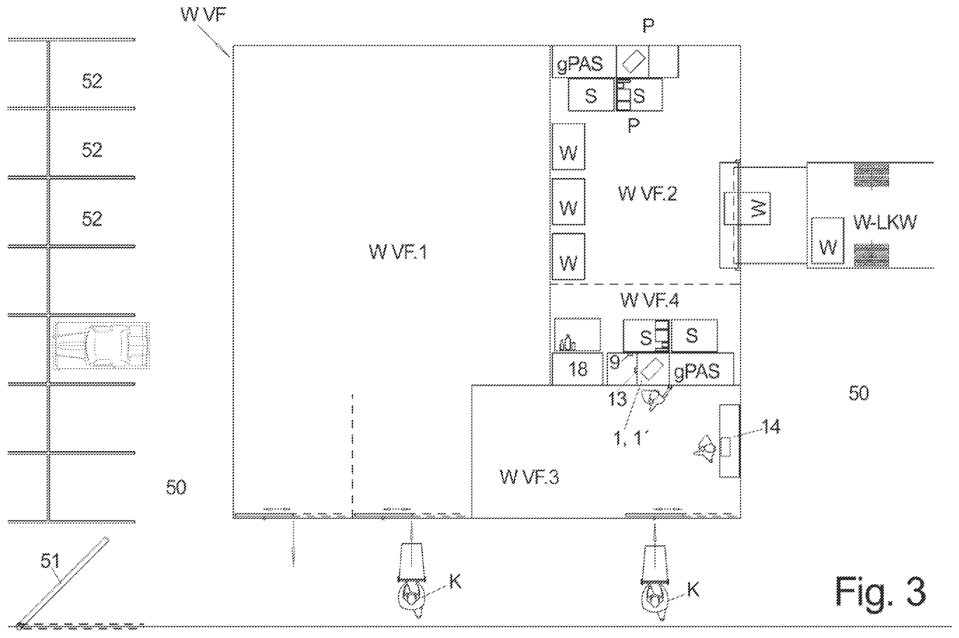

FIG. 3: a goods sales branch, cut open in the view from above.

FIGS. 1a and 1b show
on the middle vertical line the potential customers K,
left from the vertical line the—logistic company specific package acceptance stations PAS,
left of these are the PZL package central warehouses, which are logistically linked to them,
right from the vertical line the goods sales branches WVF,
right of these are the WZL goods central warehouses, which are logistically linked to them.

The package acceptance stations pass on the packages deposited at them, in particular return packages, to the package central warehouse PZL which is logistically connected to them, i.e. usually responsible for an area, while the prior delivery of the packages to the customers does not necessarily have to take place via these logistic company specific package acceptance stations, but can take place directly from the package central warehouse PZL.

The goods sales branches WVF are supplied with goods by the goods central warehouses WZL.

All package logistic streams are shown in red, goods logistic streams in blue.

According to FIG. 1a, the known method is as follows:

A customer receives an ordered package, delivered to his home either directly from the package central warehouse by means of a package delivery truck, or from the package acceptance station PAS, from where he then usually collects it himself. If the goods are not completely or partially satisfactory, they are returned by the customer himself to the logistic company specific package acceptance station PAS, where they are picked up and taken to the package central warehouse PZL. From there, it is usually first taken to another package central warehouse PZL nearest to the recipient, usually an online sender, and from there delivered to the recipient.

One of the customers, possibly the same customer who ordered and returned the package, often buys goods for his daily needs in a goods sales branch WVF.

These goods are delivered with goods trucks from a responsible goods central warehouse WZL, whereby these goods trucks are hardly loaded on the return trip.

FIG. 1b shows the method according to the invention.

This differs from FIG. 1a in that the customer K, who has received an ordered package in the way described but wants to return it as a return package to the original sender, e.g. the operator of the online store, does not hand it over in one of the logistic company specific package acceptance stations PAS, but hands it over at one of the common package acceptance stations gPAS located at or in the WVF.

This saves him a detour to the PAS positioned at another location, and he can do it during his daily shopping, which he does anyway in a WVF.

The packages deposited in each gPAS, i.e. each WVF, are transported by the goods trucks delivering the goods there on their return trip to the WZL, for which enough storage space is also available in the goods truck.

Preferably only at the WZL, these return packages are sorted according to the individual package logistic companies and—usually by the corresponding package logistic company itself—picked up at the WZL and usually transported to the nearest, own PZL.

If the package logistic company in the WZL also already sorts these return packages according to the recipients or the receiving areas, the corresponding package tranches can already be fed to the nearest PZL.

The advantages of this method are:
the customer saves additional way and time for dropping off the return package in a logistic company specific PAS,
the customer has access to the much longer and more customer-friendly opening hours of the WVF instead of the shorter and at each PAS different opening hours of the different PAS,
the operator of the WVF thereby increases customer loyalty,
The package logistic company receives a large proportion of its packages, in particular returned packages, offered in concentrated form at a relatively small number of WZLs and saves time-consuming collection at a much larger number of its own PASs.

In the medium term, the package logistic company can even do without its own package acceptance station PAS, especially if the commonpackage acceptance stations gPAS are also equipped to accept and, in particular, frank primary packages.

FIG. 3 shows two possible arrangements of a common package acceptance station gPAS in a goods sales branch WVF:

The area with the building of a goods sales branch WVF, which is not shown in a realistic size distribution, is divided into the goods sales room WVF.1—which usually takes up by far the largest part of the floor space of the building of the goods sales branch WVF—with an entrance and exit area in front, through which the customers K enter and leave the goods sales room WVF.1.

Usually adjacent to the entrance area, but usually separated therefrom, is a return room WVF.3 in which a return vending machine 18 for refunded containers is located, usually recessed in a wall of the return room WVF.3 so that the rear side of the return vending machine 18 is accessible to the personnel of the goods sales branch WVF, preferably from a refund room WVF.4 adjacent to the rear side of the return vending machine 18.

A logistics room WVF.2, where pallets or roll carts of new goods delivered by goods trucks W-LKW are temporarily stored before being taken to the sales room WVF.1 where the goods are put in the shelves, being often located next to the refund room WVF.4 and in some cases may be identical to it.

In the logistics room WVF.2 and/or the refund room WVF.4, those items are often also temporarily stored which, after unloading the goods W from the goods truck W-LKW, have to be loaded onto the latter so that it can take them with it on its return trip to the goods central warehouse WZL, for example collector containers S filled with returned collectord containers, but also goods returns and the like.

As a first possibility, the common package acceptance station gPAS can also be accommodated in the return room WVF.3, preferably again recessed in a wall there, preferably next to the return vending machine 18, so that the rear of the gPAS is also accessible to the personnel from the rear, namely from the refund room WVF. 4, for example for removing a collector container S filled with checked-in packages from the rear of the common package acceptance station gPAS and placing a new, empty collector container S there.

The common package acceptance station gPAS may also be located in an outer wall of the building of the goods sales branch WVF, preferably again in such a way that the rear side of the common package acceptance station gPAS is accessible to the personnel from the inside of the building, preferably the logistics room WVF.2.

After intermediate storage in the logistics room WVF.2, the collector containers S filled with packages are also taken along by the goods trucks W-LKW on their return trip to the goods central warehouse.

The entrance door to the return room WVF.3 is usually only open at the same times than the entrance to the goods sales room WVF.1.

The area 50 on which the goods sales branch WVF is located is usually enclosed, for example fenced, and the access to the area 50, on which the parking spaces 52 for the customers K are also located, can usually be closed by an access restriction such as a barrier 51. Customers K thus normally only have access to a common package acceptance station gPAS located in the return room WVF.3 during the opening hours of the goods sales branch WVF, unless the entrance door to the return room WVF.3 would be left open longer than the access to the goods sales room WVF.1.

If, on the other hand, the common package acceptance station gPAS is located in an outer wall of the building of the goods sales branch WVF—or even in a separate building on the area 50 of the goods sales branch WVF—this opens up the possibility of leaving the access restriction, for example the barrier 51, open longer than the opening hours of the goods sales room WVF.1 of the goods sales branch WVF, and thus to enable the customer K to use the common package acceptance station gPAS for an even longer period of time than the opening hours of the goods sales room WVF.1.

FIG. 2 shows an example of a front view of a common package acceptance station gPAS as seen by the customer K when using it:

This comprises, on the one hand, the input opening 1, which is adjoined by an input channel 1′ in the viewing direction of FIG. 2, and into which the customer K places the package P to be handed over, namely on a transport device 2 in the form of a conveyor belt running in this input channel 1′ in the viewing direction.

Next to this is a operating unit 10 with a screen, i.e. display 5, which is usually designed as a touch-sensitive screen, as well as a keyboard 6. The operating unit 10 also generally comprises a payment unit 8, which usually functions without cash, for example an EC and/or credit card terminal 8 for entering a card, as well as a receipt generator 3, via which the customer is issued a receipt after placing his package P. The receipt generator 3 is designed to generate a receipt.

Preferably, a scanner 4, for example in the form of a QR code reader or bar code reader, is further provided on the operating unit 10 in order to be able to read the QR code or bar code located on accompanying documents of the package P, for example a return order of the logistics company.

The control system of the entire common package acceptance station gPAS, which is not shown, is also preferably accommodated in a protected manner in the housing of the operating unit 10, in particular accessible from the rear side thereof.

Furthermore, an emergency button 16 is provided at the common package acceptance station gPAS, either as part of the operating unit 10 or separately in a conspicuous location, including in the vicinity of the input opening 1, which the customer K can actuate if, for example, a malfunction of the common package acceptance station gPAS occurs when placing the package P, and with which he can alert personnel of the goods sales branch WVF.

The input channel 1′ can have further equipment features that facilitate the handling of the packages P for the operator of the common package acceptance station gPAS:

Since, on the one hand, the weight of the package P is of interest, a scale 7 can be installed, preferably in operative connection with the conveyor belt 2, which weighs the package P deposited thereon as it is transported into and through the input channel 1′ until it falls into the collector container S—as can be seen in FIG. 3.

Since the dimensions of the individual packages are also of interest, an automatic measuring device can be provided for this purpose, in this case divided into a first measuring device 11.1, which extends in a side wall of the input channel 1′ over the entire height thereof and determines the height of the package P, and a second measuring device 11.2, which extends in the ceiling wall of the input channel 1′ over substantially the entire width thereof and determines the width of the package P.

If the determination of the height and width takes place during the movement of the package P through the input channel 1′, one of the two measuring devices 11.1, 11.2 can also be designed in such a way that the beginning and the end of the package P during the passage and thus the length of the package P in the viewing direction of FIG. 2 is determined with it.

Furthermore, only on one or also on several of the peripheral walls of the input channel 1′, a scanner 4 can also be arranged to identify markings on one of the outer sides of the package P, in particular QR codes, bar codes or other markings, which in particular identifies the package logistic company who has to transport this package P.

In the event that a customer K arrives at the common package acceptance station gPAS with a package P which has not yet been completely sealed or packed, the equipment required for this purpose is made available to the customer K in the form of, on the one hand, a working table 14, as also shown in FIGS. 2 and 3, or a fold-out or—in particular from the gPAS, preferably its input opening—pull-out work plate, dispensers for packaging material 15 such as wrapping paper 15.1 and adhesive tape 15.2, which can be withdrawn from a corresponding withdrawal slot from a supply roll located behind it and, after separation, can be removed for final packaging of the package P.

If the common package acceptance station gPAS is additionally to fulfill the function of a package delivery, the common package acceptance station gPAS can have lockable output shelfs 17 for this purpose, of which only two are shown in FIG. 2, and which are each filled from the rear by the staff of the goods sales branch WVF with a package to be fetched, so that, after input of certain authorization data by the customer K at the operating unit 10, the door in the front side of the output shelf 17 in the front side of the common package acceptance station gPAS is opened for the customer K, so that he can take out his package P located therein.

Alternatively, the customer K can also be issued his package P via the input channel 1′, which then functions as an output channel in that the transport device such as the conveyor belt 2 is driven in the direction to the opening 1, after the correct package P, to which the customer K is entitled, has previously been automatically placed on the conveyor belt 2 from the rear of the common package acceptance station gPAS and moved forward to the customer K from a storage for stored packages not shown.

### REFERENCE LIST

1 input opening

1′ input channel

2 transport device, conveyor belt

3 receipt generator

4 scanner

5 display

6 keyboard, real or virtual shown in the display

7 scale

8 payment unit, creditcard terminal

9 level sensor

10 operating unit

11 measuring device

11.1, 11.2 measuring device

12 output unit (for packaging material)

13 position sensor, motion sensor

14 working table

15 packaging material

15.1 wrapping paper

15.2 adhesive tape

16 emergency button

17 output shelf

18 refund-container-return-automat, return vending machine

50 area

51 barrier

52 parking space

K customer

P package

Pr return package

PAS package acceptance station

gPAS common package acceptance station

PL package logistic company

PZL package central warehouse

S collector container

W goods

W truck, goods-truck

WVF goods-sales-branch

WVF.1 sales room

WVF.2 logistics room

WVF.3 return room

WVF.4 refund room

WZL goods central warehouse

1. Method for logistic handling of packages to be sent (P) and goods to be sold (W) from goods sales branches (WVF), by
A) Goods (W) are transported from a goods central warehouse (WZL) to the goods sales branches (WVF) in their distribution area by means of goods trucks,
B) in particular empty packaging is transported by the goods trucks on the return trip from the goods sales branches (WVF) to the goods central warehouse (WZL),
a) packages (P), in particular returned packages (P), are delivered by customers (K) at automated or manual package acceptance stations (PAS), and
b) transported from there to a package central warehouse (PZL) of a package logistics company (PL),
characterized in that
the packages (P), in particular franked packages, are delivered by the customer (K) at a respective, in particular automated, common package acceptance station (gPAS),
which are embodied to accept for several different package logistic companies (PL) and
positioned at or in the goods sales branches (WVF),
the packages (P) are sorted at least according to the different package logistic companies (PL) and
be transferred to the individual package logistic companies (PL),
transported to the package central warehouses (PZL) of the individual package logistic companies (PL).

2. Method according to claim 1,
characterized in that
the packages (P) are transported from the goods-sales branches (WVF) to the goods-central warehouse (WZL) in particular by means of the goods trucks on their return trip,
the packages (P) are sorted there at the latest, at least according to package logistic companies (PL) and
the logistic company specific sorted packages (P) are transported from the goods central warehouse (WZL) to the package central warehouse (PZL) in particular by means of package trucks, in particular by the package logistic companies.

3. Method according to claim 1,
characterized in that
the packages (P) are sorted in the goods sales branches (WVF), at least according to package logistic companies (PL) and
the logistic company specific sorted packages (P) are transported from the goods sales branch (WVF) to the package central warehouse (PZL), in particular by means of package delivery vans or package trucks.

4. Method according to claim 1 any one of the preceding claim,
characterized in that
after the package (P) has been delivered to the commonpackage acceptance station (gPAS), a delivery receipt is automatically issued in paper form or online to the customer (K), on which the following is noted
the delivery time,
and/or
the package logistic company (PL) indicated on the package (P),
and/or
a delivery identifier that enables online tracking of the package (P) by the customer.

5. Method according to claim 1,
characterized in that
the package information present on the package (P), in particular on its label, is automatically scanned upon entry into the common package acceptance station (gPAS), and
the package (P) is automatically fed to a collector container (S) for the package logistic company (PL) determined,
and/or
the package logistic company (PL) is informed, especially just-in-time, about the number of packages (P) delivered in each goods sales branch (WVF) or in the distribution area of a goods central warehouse (WZL),
in particular, broken down by recipient,
in particular, indicating the delivery identifier of the specific package (P), and/or
the return packages (Pr) of the goods sales branch own online store are determined and the latter is promptly informed of the number of returns present, in particular by stating the delivery ID of the specific package (P).

6. Method according to claim 5,
characterized in that
from the package (P) when entered into the common package acceptance station (gPAS) automatically.
the weight,
and/or
the dimensions, especially the maximum dimension,
and/or
the shape
is determined,
and/or
this information is additionally transmitted to the package logistic company (PL), especially just-in-time.

7. Method according to claim 1,
characterized in that
the packages (P) are paid for, in particular franked, at or in the package acceptance station (gPAS) with regard to the shipping costs,
in particular the transport costs, preferably cashless, be paid by the customer (K) at the common package acceptance station (gPAS) or, in particular beforehand, online, and/or
in particular, after the customer (K) has selected the desired package logistics company (PL), which takes place at the latest at the common package acceptance station (gPAS).

8. Method according to claim 7,
characterized in that
if no package logistics company (PL) is bindingly indicated on the entered package (P) yet the customer is informed of the respective transport costs incurred by the various package logistics companies (PL) available at the common package acceptance station (gPAS) for the transport of this package, in particular also the transport time until delivery to the recipient,
the customer selects one of these package logistic companies.

9. Method according to claim 1,
characterized in that
packaging material (15), in particular adhesive tape (15.2) and/or wrapping paper (15.1) and/or folding cartons, are made available to the customer (K) at the common package acceptance station (gPAS) for self-service, free of charge or against payment, in the latter case by automatic dispensing after payment.

10. Method according to claim 1,
characterized in that
when a filled collector container (S) is removed from the common package acceptance station (gPAS), at least one plausibility check is carried out with regard to the filling of the collector container (S),
in particular the weight and/or volume of the filling of packages (P) located in the collector container (S) is compared with the weight and/or volume of the packages (P) accepted at the package acceptance station (gPAS), in particular for this collector container (S),
if the result of the comparison is negative, an alarm signal is given to the personnel responsible for the package acceptance station (gPAS).

11. Method according to claim 1 any one of the preceding claims,
characterized in that
the common package acceptance station (gPAS) is monitored for safety,
especially is automatically connected to the nearest police station, especially in terms of signaling.

12. Method according to claim 1,
characterized in that
the customer (K) inserts one or more goods (W) into the input opening (1) and declares these goods (W) at the operating unit (10) as a donation for the boards, or
the customer (K) orders and pays for one or more goods (W) at the operating unit (10) as a donation for the boards,
the entered or ordered goods (W) are then fed, in particular automatically, to a donation container for the boards, which is preferably located in the logistics room (WVF.2).

13. Method according to claim 1,
characterized in that
a package (P) is automatically dispensed to the customer (K), in particular by opening a output shelf (17) in which the package (P) is located,
in particular of a package (P) containing a product, usually a high-priced product, previously purchased and paid for by the customer in the relevant goods sales branch (WVF),
and/or
especially of a package (P) delivered by a package logistic company (PL) to the package acceptance station for the customer.

14. Package acceptance system with at least one common package acceptance station (gPAS),
wherein the common package acceptance station (gPAS) comprises.
an input opening (1), in particular an input channel (1′) adjoining it,
at least one collector container (S) for the packages (P),
an internal transport device (2), in particular a chute or a conveyor belt (2), from the input opening (1) to the collector container (S),
a receipt generator (3) for generating a delivery receipt,
where the package receiving system includes
a scanner (4) for reading the package information indicated on the package (P), especially on its label,
characterized in that
the scanner (4) is designed to read the logistician identifier present on the package (P), in particular a QR code or bar code, of one of several specific package logistic companies (PL).

15. Package acceptance system according to claim 14,
characterized in that
the common package acceptance station (gPAS) includes
the scanner (4),
and/or
a scale (7) for weighing the package (P),
and/or
a cashless payment unit (8), in particular an EC terminal (8),
and/or
a level sensor (9) for the at least one collector container (S).

16. Package acceptance system according to claim 14,
characterized in that
the common package acceptance station (gPAS) includes
a measuring device (11) for determining the dimensions, in particular the largest dimension, and/or the shape of the package (P),
and/or
an operating unit (10) with a display (5), in particular a touch display (5), and/or
a reach-through protection behind the input opening (1), in particular at the beginning of an input channel (1′) starting behind it, and/or
a output unit (12) for packaging material (15), and/or
a position sensor (13) and/or motion sensor (13) for determining the position and/or movement of a package (P) located in the input channel (1′).

17. Package acceptance system according to claim 14,
characterized in that
several collector containers (S) for packages (P) assigned to different package logistic companies are present,
at least one automatic switch is provided for automatically feeding a package (P) to a logistic company specific collector container (S) as a function of the scanned logistician identifier,
and/or
the scanner (4) is embodied to read the recipient identifier of a specific recipient, in particular an online sender, present on the package (P), in particular on its label.

18. Package acceptance system according to claim 14,
characterized in that
a security monitoring system for the common package acceptance station (gPAS) is present, which comprises in particular
at least one camera, in particular coupled with a motion detector, which films at least the operating side of the common package acceptance station (gPAS) as well as its surroundings, and/or
an emergency button (16) which, when triggered, informs the personnel responsible for operating this common package acceptance station (gPAS), and/or
an automatic, signaling connection to the nearest police station.

19. Goods-Sales-Branch (WVF),
characterized in that
the goods-sales-branch (WVF) comprises a common package acceptance station (gPAS) according to claim 14.

20. Goods-sales-branch according to claim 19, which comprises.
a main building with a sales room (WVF.1) for goods therein,
a return room (WVF.3), in particular separable therefrom, with at least one packaging return vending machine (18), in particular a refund-container-return-automat (18), therein
characterized in that
the common package acceptance station (gPAS) is arranged
in the return room (WVF.3),
and/or
accessible from outside the main building in an external wall of the main building,
and/or
near the main building,
and/or
is embodied as a drive-in station.

21. Goods-sales-branch according to claim 19,
characterized in that
a safety monitoring system for the goods sales branch (WVF) is existing, which in particular includes the safety monitoring system for the common package acceptance station (gPAS),
in particular includes the local area of the package acceptance station (gPAS).
